(19) United States
(12) Patent Application Publication
(10) Pub. No.: US 2026/0094149 A1
(43) Pub. Date: Apr. 2, 2026

(54) System and Method to Dynamically Validate Request to Access Network Resources

(71) Applicant: Cisco Technology, Inc., San Jose, CA (US)

(72) Inventors: Nancy P. Cam-Winget, Mountain View, CA (US); Andrew C. Lim, Dexter, MI (US); Rajvardhan Somraj Deshmukh, San Jose, CA (US); Joshua M. Green, London (GB); Matthew Miller, Irvine, CA (US)

(21) Appl. No.: 19/061,213

(22) Filed: Feb. 24, 2025

Related U.S. Application Data
(60) Provisional application No. 63/701,068, filed on Sep. 30, 2024.

(51) Int. Cl. G06Q 20/36

(52) U.S. Cl. CPC G06Q 20/3674

(57) ABSTRACT

A system includes a memory communicatively coupled to at least one processor. The at least one processor is configured to receive a request to generate a digital credential for a candidate profile, generate a request bitstring representative of the candidate information, determine whether the request bitstring matches a reference bitstring of the one or more reference bitstrings in the reference repository, determine that the candidate information is verified, and determine one or more claims based on one or more entitlements. Further, the at least one processor is configured to generate the digital credential for the candidate profile representative of the candidate information and the claims, generate a private key configured to create a signature for the digital credential, sign the digital credential in using the private key, and issue an signed version of the digital credential to a digital wallet associated with the candidate profile.

### RELATED APPLICATIONS

This application claims priority to U.S. patent application Ser. No. 63/701,068, filed Sep. 30, 2024, which is hereby incorporated by reference in its entirety.

### TECHNICAL FIELD

The present disclosure relates generally to a field of application asset protection, and more particularly, to a system and method to dynamically validate a request to access network resources.

### BACKGROUND

With the current dependencies of Software as a Service (SaaS) and the internet, the process for onboarding potential employees is a multi-step process that has security gaps. For example, during the interview phase, a user's identity is not verified and thus is generally not authenticated. As such, it is possible that new hires arriving on their first day are not the individuals who were interviewed. There are documented cases of this issue occurring with corporate and international espionage implications. As another example, with a user ready to join an organization, the onboarding process is a multi-step process that currently requires access from multiple personnel in the organization, some with manual intervention and some pursuing insecure methods such as sending user credentials in cleartext or sending a link without identity verification to create such credentials. Furthermore, any transitions and relationship between human resources (e.g., human resources and payroll) to interview and onboard a candidate and information technology (IT) to provide access between a candidate and an organization's resources is often manual and susceptible to mistakes.

Large organizations having several employees often have significant yearly expenditures related to security issues in hiring processes. For example, background checks may fail, credentials may be compromised, and the recovery of IT assets may end up in the wrong hands. As organizations embrace a remote and hybrid workplace, risks of identity security issues increase.

### BRIEF DESCRIPTION OF THE DRAWINGS

For a more complete understanding of the present disclosure and for further features and advantages thereof, reference is now made to the following description taken in conjunction with the accompanying drawings, in which:

FIG. 1 illustrates a system for dynamically validating a request to access network resources, according to some embodiments of the present disclosure;

FIG. 2 illustrates an operational flow that may be used by the system of FIG. 1 to dynamically onboard an entity into an organization, according to some embodiments of the present disclosure;

FIG. 3 illustrates another operational flow that may be used by the system of FIG. 1 to dynamically confirm an entity previously onboarded into an organization, according to some embodiments of the present disclosure; and

FIGS. 4A and 4B illustrate processes for performing the operational flows of FIGS. 2 and 3, respectively, according to some embodiments of the present disclosure.

### DESCRIPTION OF EXAMPLE EMBODIMENTS

### Overview

In one or more embodiments, a system and method described herein dynamically validate a request to access network resources. In some embodiments, the system and method are configured to automatically onboard entities onto organizations using digital credentials. The method may include receiving one or more credentials from a candidate, verifying the one or more credentials, generating a digital credential based on the one or more credentials, and issuing the digital credential to the candidate. The method may also include receiving the digital credential from the candidate, verifying the digital credential using an organization's public key, and issuing access between the organization's resources and the candidate.

Current onboarding processes lack a chain of continuity from interview through to onboarding. This introduces several avenues for attacks on the integrity of the onboarding process. For example, the person who onboards for the job may not be the employee to be onboarded who was first contacted. As another example, credentials and/or IT assets may be accidentally delivered to the wrong person due to the inability to verify the identity of candidates and new joiners. This disclosure establishes a process for verifiably identifying a job candidate from the first interview and continuing that chain of continuity through the final onboarding process.

Certain embodiments of this disclosure describe systems and methods to pre-provision a candidate employee or contractor during the hiring process with a digital credential (e.g., a token, a “verifiable credential” (VC), an x.509 certificate or the like) that is used by the enterprise to assist with onboarding that individual. The digital credential is then used during the onboarding from the inclusion of the candidate into the human resources database to the provisioning of their “account” (e.g., credentials and entitlements) in an automated workflow. This is achieved by establishing a chain of identity authenticity from the moment the candidate (asset) has the potential to be onboarded to the enterprise.

In certain embodiments, a chain of identity authenticity is established from the point of first contact with a job candidate, which addresses weaknesses in existing manual human resources processes. Potential employees and contractors are securely and reliably authenticated from the interview stage itself, which mitigates emerging impersonation attacks. Along with the digital credentials, ceremonies and challenges are utilized to detect deep fakes on video calls. The steps for the onboarding include an interview stage and an onboarding stage.

In accordance with one or more embodiments, a system or an apparatus, such as a network component, includes a memory and at least one processor communicatively coupled to one another. The memory may be operable to store a reference repository including one or more reference bitstrings. The at least one processor may be configured to receive a request to generate a digital credential for a candidate profile, generate a request bitstring representative of the candidate information, determine whether the request bitstring matches a reference bitstring of the one or more reference bitstrings in the reference repository, determine that the candidate information is verified in response to determining that the request bitstring matches the reference bitstring of the one or more reference bitstrings in the reference repository, and determine one or more claims based on one or more entitlements in response to determining that the candidate information is verified. The candidate profile may include candidate information and the one or more entitlements. The one or more claims may be representative of one or more portions of the candidate information. Further, the at least one processor may be configured to store the one or more claims in a secured storage, generate the digital credential for the candidate profile representative of the candidate information, generate a private key configured to create a signature for the digital credential, sign the digital credential using the private key, and issue a signed version of the digital credential to a digital wallet associated with the candidate profile.

In some cases, the at least one processor is further configured to receive an additional request to generate an additional digital credential for an additional candidate profile. The additional candidate profile may include additional candidate information and one or more additional entitlements. Further, the at least one processor is configured to generate an additional request bitstring representative of the additional candidate information, determine whether the additional request bitstring matches an additional reference bitstring of the reference bitstrings in the reference repository, determine that the additional candidate information is not verified in response to determining that the additional request bitstring does not match the additional reference bitstring of the reference bitstrings in the reference repository, and deny the additional request to generate the additional digital credential for the additional candidate profile in response to determining that the candidate information is not verified.

In certain cases, the candidate information is representative of image data captured in by a sensor. Further, the candidate information is representative of a unique digital biometric associated with a user.

In some cases, the at least one processor is further configured to receive a validation request to associate access to one or more network resources in a network with the candidate profile, retrieve the claims from the secured storage, retrieve a public key from a key storage hosted in the network, receive the signed version of the digital credential from the digital wallet associated with the candidate profile, determine a candidate signature based on the public key in response to receiving the signed version of the digital credential from the digital wallet associated with the candidate profile, calculate a claim signature based on the claims, determine whether the candidate signature matches the claim signature, determine that the signed version of the digital credential from the digital wallet associated with the candidate profile is valid in response to determining that the candidate signature matches the claim signature, and associate access to the one or more network resources in the network with the candidate profile in response to determining that the signed version of the digital credential from the digital wallet associated with the candidate profile is valid.

In some cases, the at least one processor is further configured to receive a validation request to associate access to one or more network resources in a network with the candidate profile, retrieve the claims from the secured storage, retrieve a public key from a key storage hosted in the network, determine whether the digital wallet associated with the candidate profile is accessed using biometrics associated with the candidate profile, receive the signed version of the digital credential from the digital wallet associated with the candidate profile in response to determining that the digital wallet associated with the candidate profile is accessed using the biometrics associated with the candidate profile, determine a candidate signature based on the public key in response to receiving the signed version of the digital credential from the digital wallet associated with the candidate profile, calculate a claim signature from the claims, determine whether the candidate signature matches the claim signature, determine that the signed version of the digital credential from the digital wallet associated with the candidate profile is valid in response to determining that the candidate signature matches the claim signature, and associate access to the one or more network resources in the network with the candidate profile in response to determining that the signed version of the digital credential from the digital wallet associated with the candidate profile is valid.

In some cases, the at least one processor is further configured to receive a validation request to associate access to one or more network resources in a network with the candidate profile, retrieve the claims from the secured storage, retrieve a public key from a key storage hosted in the network, receive the signed version of the digital credential from the digital wallet associated with the candidate profile, determine a candidate signature based on the public key in response to receiving the signed version of the digital credential from the digital wallet associated with the candidate profile, calculate a claim signature from the claims, determine whether the candidate signature matches the claim signature, determine that the signed version of the digital credential from the digital wallet associated with the candidate profile is not valid in response to determining that the candidate signature does not match the claim signature, and deny access between the one or more network resources in the network and the candidate profile in response to determining that the signed version of the digital credential from the digital wallet associated with the candidate profile is not valid.

In one or more embodiments, the secured storage includes a centralized database where additional claims associated with additional candidate profiles are stored. In other embodiments, the secured storage includes one or more decentralized databases that together store additional claims associated with additional candidate profiles. Further, the signed version of the digital credential is issued to the digital wallet associated with the candidate profile for a predefined time duration.

In accordance with other embodiments, one or more methods performed by the systems include receiving a request to generate a digital credential for a candidate profile. The candidate profile may include candidate information and multiple entitlements. The method may further include generating a request bitstring representative of the candidate information, determining whether the request bitstring matches a reference bitstring of multiple reference bitstrings in a reference repository, determining that the candidate information is verified in response to determining that the request bitstring matches the reference bitstring of the reference bitstrings in the reference repository, and determining multiple claims based on the entitlements in response to determining that the candidate information is verified. The claims may be representative of one or more portions of the candidate information. The method may include storing the claims in a secured storage, generating the digital credential for the candidate profile representative of the candidate information, generating a private key configured to create a signature for the digital credential, and signing the digital credential using the private key. The method may include issuing the encrypted version of the digital credential to a digital wallet associated with the candidate profile.

In accordance with yet other embodiments, a non-transitory computer-readable medium storing instructions that, when executed by a processor, cause the processor to receive a request to generate a digital credential for a candidate profile. The candidate profile may include candidate information and multiple entitlements. The processor may be further caused to generate a request bitstring representative of the candidate information, determine whether the request bitstring matches a reference bitstring of multiple reference bitstrings in a reference repository, determine that the candidate information is verified in response to determining that the request bitstring matches the reference bitstring of the reference bitstrings in the reference repository, and determine multiple claims based on the entitlements in response to determining that the candidate information is verified. The claims may be representative of one or more portions of the candidate information. The processor may be further caused to store the claims in a secured storage, generate the digital credential for the candidate profile representative of the candidate information, generate a private key configured to create a signature for the digital credential, and sign the digital credential using the private key. The processor may be further caused to issue the encrypted version of the digital credential to a digital wallet associated with the candidate profile.

Technical advantages of certain embodiments of this disclosure may include one or more of the following. The system and method described herein prevent, inhibit, and/or eliminate gaps in onboarding processes and access to sensitive resources in an organization. Further, the system and method are configured to generate credentials that a candidate can use to access resources without providing a copy of a sensitive document. For example, the system and method may be used to onboard a candidate from a driving records platform. Herein, the candidate may be onboarded from a driving records platform, where the driving records platform issued as a root of identity for the candidate. The credential issued during an interview may be used to onboard candidates that become employees. This employee onboarding process may involve issuing credentials (e.g., digital credentials) to enable physical and/or digital access to network resources and systems. Herein, the use of a driving records is representative of a use of a trusted platform (e.g., the driving record, or it could be a government issued credential or a trusted third party identify proofer service) that is used to serve as a “root of identity” that is used to validate as part of the creation of a digital credential that serves as a “root” credential issued by the organization from which other credentials or access tokens may be generated. The candidate's identity may be verified, and a digital credential may be generated for the candidate as a result. If the candidate is part of a traffic stop in a location that allows use of digital credentials in place of driver's license to confirm a driver's identity, the candidate may be able to provide the digital credential to a traffic rules enforcer (e.g., police officer) to confirm the candidate's identity. In this scenario, the system works to confirm the identity of the driver, while sensitive information of the candidate that is not needed by the traffic rules enforcer may be kept obscured to protect the driver's privacy while complying with local rules and/or policies. In this example, the traffic rules enforcer may need access an age, physical aspects of the candidate such as height, name, and expiration date associated with the driver's license and may not need access to the full birth date or the home address of the candidate. Further, the system and method are integrated into a practical application of inhibiting, reducing, and/or eliminating risks to sensitive information loss. In the process of storing in confirming digital credentials, the system and method may be configured to only corroborate that a digital credential is active and/or is associated with entitlements to access specific network resources. In this regard, if a database including digital credentials were to be compromised in a cyberattack, bad actors performing the cyberattack would-at most - access digital credentials associated with an organization without obtaining access to all sensitive data associated with candidates.

Certain embodiments described herein streamline and securely automate the onboarding process inclusive of the identity verification required to bootstrap the security assurances during onboarding. Some embodiments allow for automated flows that are triggered by human resources, information technology, and/or the employee hiring manager. Certain embodiments of this disclosure mitigate identity provider-related attacks as password credentials are not used, and only public keys and permissions/privilege associations are stored. If compromised, this information cannot be used to impersonate a user.

In addition, the system and method described herein are integrated into a practical application of increasing processing speed and reducing memory usage in the system. Specifically, the system and the method reduce or eliminate delays or data congestions caused by manual onboarding procedures where an organization's “first contact” with a candidate and the process to grant access to resources in an organization are handled using multiple identification platforms. In this regard, processing speeds are improved because digital credentials confirming user identity can be confirmed, renewed, and/or modifies along an onboarding process instead of translating identification parameters between first contact systems and access systems. In some embodiments, memory usage is reduced because the system and method do not need to store entire copies of user's records once the user's identity is verified. Herein, the systems may be configured to store claims and/or attributes of a user record that may be considered private and/or to comprise sensitive information only as claims attached directly to the digital credential. These private claims may be stored in the user's wallet and not on the hiring organization's server. For example, a digital credential that represents a candidate's passport might include a birthdate and place of birth, but a hiring organization may only request that the candidate is over the age of 18. In this case, the system may only need to store the indicator that the employee is older than 18, and not the candidate's birthdate or birthplace. In some embodiments, the digital credential is stored in databases using a common format that eliminates the complexities of maintaining databases with multiple types of information. For example, the database may only include digital credentials instead of user IDs, digital credentials, and any other combination of information including image data, text data, video data, and the like.

Other technical advantages will be readily apparent to one skilled in the art from the following figures, descriptions, and claims. Moreover, while specific advantages have been enumerated above, various embodiments may include all, some, or none of the enumerated advantages.

### EXAMPLE EMBODIMENTS

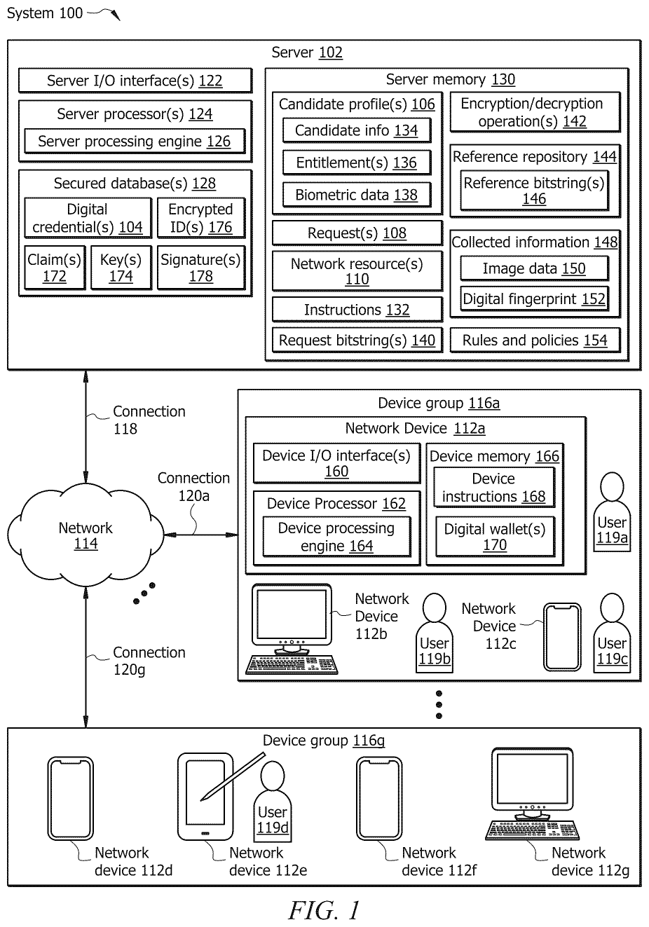

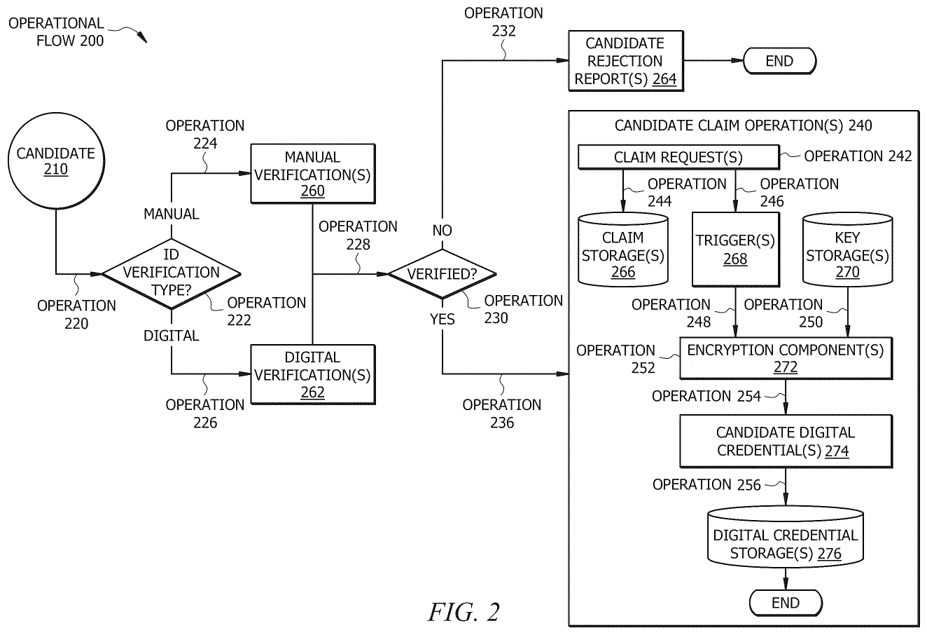

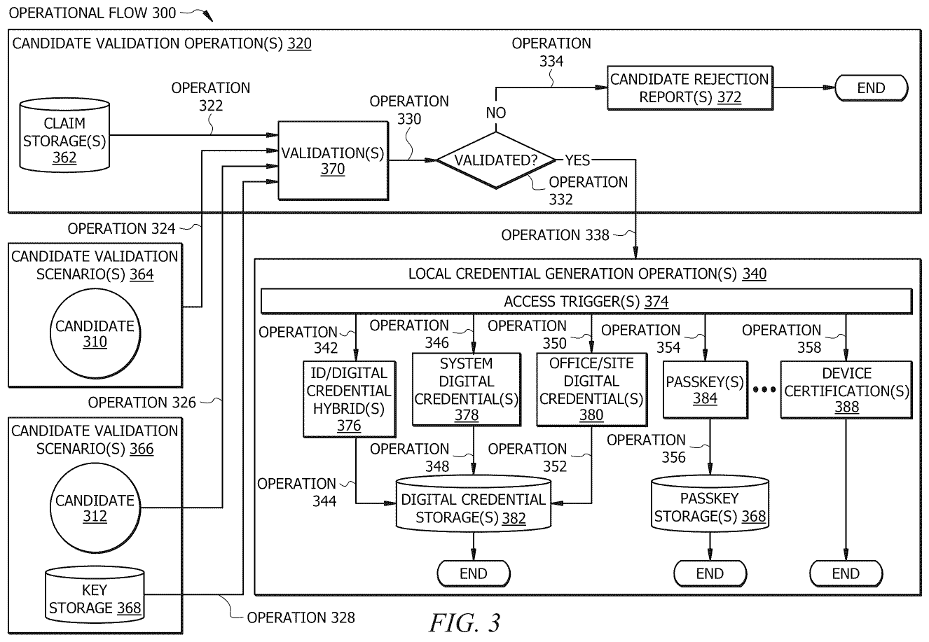

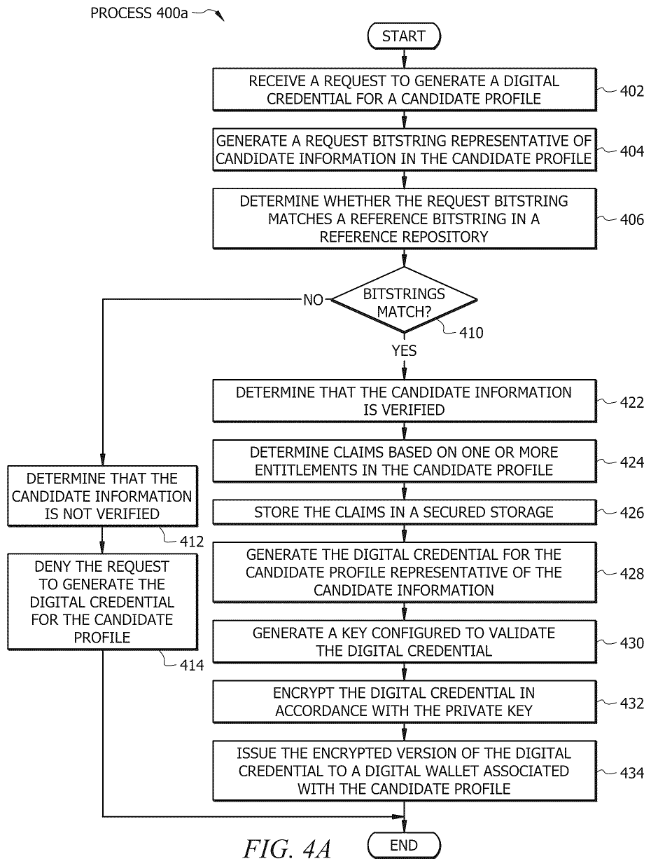

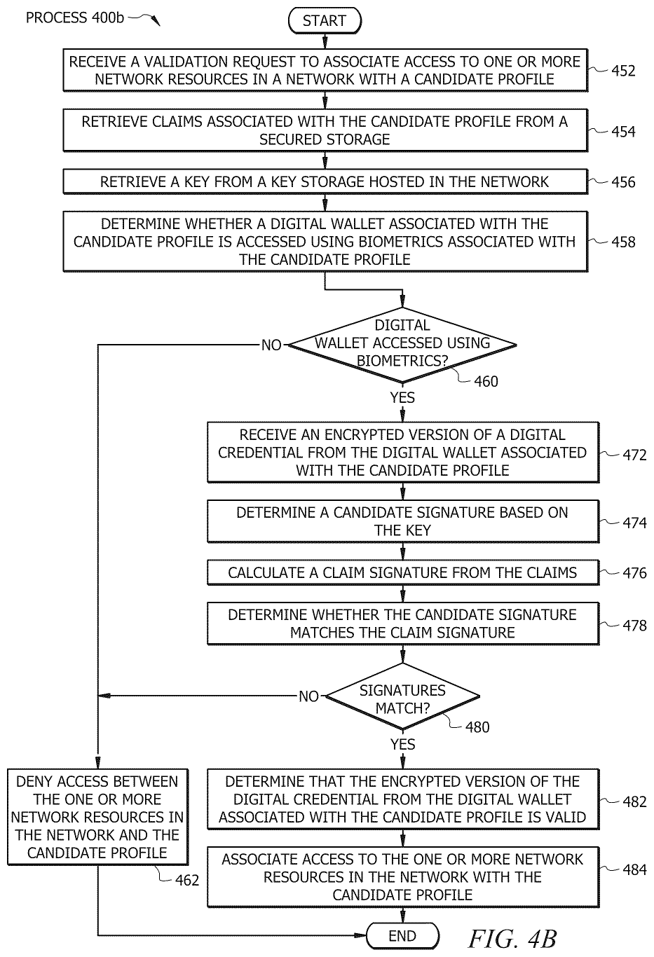

This disclosure describes systems and methods to dynamically validate a request to access network resources. In particular, this disclosure describes systems and methods for automatically onboarding entities (e.g., candidates) onto organizations using digital credentials for authentication and background check. The steps for the onboarding include an interview stage and an onboarding stage. FIG. 1 illustrates a system 100 including a server 102 configured to create one or more digital credentials 104 corresponding to one or more candidate profiles 106. FIG. 2 illustrates an operational flow 200 in which the system 100 of FIG. 1 is configured to generate one or more of the digital credentials 104. FIG. 3 illustrates an operational flow 300 in which the system 100 of FIG. 1 is configured to validate one or more of the digital credentials 104. FIGS. 4A and 4B illustrate a process 400a and a process 400b to perform the operational flow 200 of FIG. 2 and the operational flow of FIG. 3, respectively.

FIG. 1 illustrates a system 100 including a server 102 configured to dynamically validate one or more requests 108 to access network resources 110, in accordance with one or more embodiments. The network resources 110 may be processing resources, memory resources, power resources, databases, applications, services, and/or communication networks and systems associated with an organization and/or group. In some embodiments, the network resources 110 may comprise access to physical resources (e.g., servers, conference rooms, and the like), access digital resources (e.g., server memory, digitized information, applications, running on a host device, and the like), and/or services associated with an organization and/or group. In the system 100 of FIG. 1, a server 102 is shown hosting access to the network resources 110. The system 100 includes the server 102 communicably coupled to a network device 112a, a network device 112b, a network device 112c, a network device 112d, a network device 112e, a network device 112f, and a network device 112g (collectively, network devices 112) via a network 114. The network devices 112 may be grouped in one or more device groups 116a-116g (collectively, device groups 116) in accordance with corresponding locations, communication configuration, and/or organization policies. In FIG. 1, the server 102 is connected to the network 114 via a connection 118, the network devices 112a-112c in the device group 116a are connected to the network 114 via a connection 120a, and the network devices 112d-112g in the device group 116g are connected to the network 114 via a connection 120g. The device group 116a and the device group 116g are representative of multiple possible device groups 116 in a space, distributed among one or more locations. The device groups 116 may be located in warehouses, assembly facilities, residential buildings, and/or private residences. The connection 120a and the connection 120g are representative of multiple possible connections 120. The device groups 116 may include multiple distinct or separate sub-groups. In some embodiments, the server 102 may be configured to receive requests 108 from one or more of the network devices 112. The connection 118 and the connections 120 may be wired and/or wireless connections configured to enable communication between the server 102, the network 114, and the network devices 112. In other embodiments, the server 102 and the network 114 may be partially or completely located in a proximity of one or more of the device groups 116 among the network devices 112.

In one or more embodiments, as a non-limiting example, the network devices 112 may be associated with the user 119a, the user 119b, the user 119c, and the user 119d (collectively, users 119), among others. In the example of FIG. 1, the user 119a is shown associated with the network device 112a, the user 119b is shown associated with the network device 112b, the user 119c is shown associated with the network device 112c, and the user 119d is shown associated with the network device 112e. There may be multiple additional users 119 or no users 119 associated with the network devices 112. In some embodiments, the network devices 112 may be unassociated with any users 119 and perform one or more roles completely autonomously from ongoing (e.g., constant) human management or intervention. For example, the network devices 112 may be videoconferencing devices in a conference room including one or more peripherals (e.g., displays or speakers). In some embodiments, some of the network devices 112 may be part of a sub-group of network devices 112. In an example, the network device 112a and the network device 112b may be associated with one another as communication nodes (e.g., acting as routers or anchor points) performing similar tasks such as routing connectivity signals in the device group 116a. In another example, the network device 112f and the network device 112g may be associated with one another as end points of a communication link where data may be exchanged between the network device 112f and the network device 112g.

In the example of FIG. 1, the device group 116a is shown including a network device 112a, a network device 112b, and a network device 112c. Further, the device group 116g is shown including a network device 112d, a network device 112e, a network device 112f, and a network device 112g. In this example, the device group 116a may include the network devices 112 of an organization in a building, a device group 116b (implicitly referenced in the three dots between the device group 116a and the device group 116g) may include additional network devices 112 of an individual in an home, and the device group 116c (implicitly referenced in the three dots between the device group 116a and the device group 116g) may include further additional network devices 112 in a specific room of a building (e.g., a conference room). In another example, any of the device groups 116 may include one or more additional network devices 112 and one or more additional users 119 associated with in a specific department or sub-division of an organization.

In other embodiments, the server 102 may take any suitable physical form. As an example and not by way of limitation, the server 102 may be an embedded computer system, a system-on-chip (SOC), a single-board computer (SBC) system (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, a router device, or a combination of two or more of these. Where appropriate, the server 102 may include one or more computer systems, be unitary or distributed; span multiple locations; span multiple machines, span multiple data centers, or reside in a cloud, which may include one or more cloud components in one or more networks. Where appropriate, one or more computer systems may perform without substantial spatial or temporal limitation one or more operations of one or more methods described or illustrated herein. As an example, and not by way of limitation, the server 102 may perform in real-time and/or in batch mode one or more operations of one or more methods and/or one or more communication protocols described or illustrated herein. The server 102 may perform at different times and/or at different locations one or more operations of one or more methods described or illustrated herein, where appropriate.

In one or more embodiments, the server 102 may include one or more server input (I)/output (O) interfaces 122 configured to perform one or more data exchange operations, one or more server processors 124 including a server processing engine 126, one or more secure databases 128, and a server memory 130. The server I/O interfaces 122 may include hardware, software executed by software, or a combination of both, providing one or more interfaces for communication between the server 102 and one or more I/O devices. The server 102 may include one or more of these I/O devices, where appropriate. One or more of these I/O devices may enable communication between the network devices 112 and the server 102. As an example, and not by way of limitation, an I/O device may include a keyboard, keypad, microphone, monitor, mouse, printer, scanner, speaker, still camera, stylus, tablet, touch screen, trackball, video camera, another suitable I/O device, or a combination of two or more of these. An I/O device may include one or more sensors. This disclosure contemplates any suitable I/O devices and any corresponding suitable server I/O interfaces 122. Where appropriate, the server I/O interfaces 122 may include one or more device or software drivers enabling the one or more server processors 124 to drive one or more of these I/O devices. Although this disclosure describes and illustrates particular server I/O interfaces 122, this disclosure contemplates any suitable number of server I/O interfaces 122.

In one or more embodiments, the server I/O interfaces 122 may include a communication interface including hardware, software executed by hardware, or a combination of both providing one or more interfaces for communication (such as, for example, packet-based communication) between the server 102, the one or more network devices 112, the network 114, or one or more additional networks. As an example, and not by way of limitation, the communication interface of the server I/O interfaces 122 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable corresponding communication interface. As an example, and not by way of limitation, the server 102 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, the network devices 112 may communicate with a wireless PAN (WPAN) (such as, for example, a Bluetooth WPAN), a WI-FI network, a WI-MAX network, a cellular telephone network (such as, for example, a Global System for Mobile Communications (GSM) network, a Long-Term Evolution (LTE) network, or a 5G network), or other suitable wireless network or a combination of two or more of these. The server 102 may include any suitable communication interface for any of these networks, where appropriate. Although this disclosure describes and illustrates the server I/O interfaces 122 including particular communication interfaces, this disclosure contemplates any suitable communication interface.

In some embodiments, the server I/O interfaces 122 may include access to the one or more secured databases 128 communicatively coupled to the one or more server processors 124 and the server memory 130. The one or more secured databases 128 may include the one or more wired connections that share an internal bandwidth for data packet transmissions inside the server 102 with the server memory 130. The one or more secured databases 128 may be configured with a buffering capacity and a memory speed. The buffering capacity may indicate a buffering capacity (in bytes) that the storage and databases are capable of handling. For example, the buffering capacity may be 1,000 bytes. Further, the memory speed may indicate a processing speed (in bytes per second) at which the storage and databases is capable of handling or buffering data packets. For example, the memory speed may be 1,000 bytes per second. The storage and databases may include instructions and data memory for the one or more server processors 124. The secured databases 128 may be a centralized repository of data. The secured databases 128 may be a combination of secured storage locations configured to form a decentralized repository. In some embodiments, the secured databases 128 may be a secured storage comprising a centralized database where claims 172 associated with candidate profiles 106 are stored. The secured databases 128 may be communicatively coupled to one another and configured to communicate using one or more secured communication protocols and/or the blockchain. In some embodiments, the secured databases 128 may be a secured storage comprising one or more decentralized databases that together store claims 172 associated with candidate profiles 106. An example of using a decentralized database may be to store a number of claims 172 as part of a digital credential 104 only in the candidate's wallet and not in a centralized database.

In particular embodiments, the server I/O interfaces 122 may include a transceiver (e.g., transmitter, receiver, or a combination of both) configured to implement one or more wireless or wired connectivity protocols. In this regard, the transceiver may include antennas including hardware configured to establish one or more communication links (e.g., established via the connection 118 or the connections 120) between the server 102 and one or more of the network devices 112. Although this disclosure describes and illustrates the connection 118 and the connections 120, this disclosure contemplates any arrangement of channels for information exchange.

In other embodiments, the server I/O interfaces 122 may include an interconnect including hardware configured to connect the one or more server processors 124, the secured databases 128, and the server memory 130. As an example and not by way of limitation, the interconnect may include an Accelerated Graphics Port (AGP) or a graphics bus, an Enhanced Industry Standard Architecture (EISA) bus, a front-side bus (FSB), a HyperTransport (HT) interconnect, an Industry Standard Architecture (ISA) bus, an InfiniBand interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these.

In some embodiments, the one or more server processors 124 include hardware for executing instructions (e.g., instructions 132), such as those making up a computer program. As an example, and not by way of limitation, to execute instructions, the one or more server processors 124 may retrieve (or fetch) the instructions 132 from an internal register, an internal cache, or the server memory 130; decode and execute them; and then write one or more results to an internal register, an internal cache, or the server memory 130. Specifically, the one or more server processors 124 may include one or more internal caches for data, instructions, or addresses. This disclosure contemplates the one or more server processors 124 including any suitable number of internal caches, where appropriate. As an example, and not by way of limitation, the one or more server processors 124 may include one or more instruction caches, one or more data caches, and one or more translation lookaside buffers (TLBs). Instructions in the instruction caches may be copies of instructions 132 in the server memory 130, and the instruction caches may speed up retrieval of those instructions by the one or more server processors 124. Data in the data caches may be copies of data in the server memory 130 for instructions executing at the one or more server processors 124 to operate on via one or more server processing engines 126; the results of previous instructions executed at the one or more server processors 124 for access by subsequent instructions executing at the one or more server processors 124 or for writing to the server memory 130, or other suitable data. The data caches may speed up read or write operations by the one or more server processors 124. The TLBs may speed up virtual-address translation for the one or more server processors 124. In particular embodiments, the one or more server processors 124 may include one or more internal registers for data, instructions, or addresses. This disclosure contemplates the one or more server processors 124 including any suitable number of suitable internal registers, where appropriate. Where appropriate, the one or more server processors 124 may include one or more arithmetic logic units (ALUs); be a multi-core processor; or include one or more additional one or more server processors 124. Although this disclosure describes and illustrates a particular processor, this disclosure contemplates any suitable processor.

In one or more embodiments, the one or more server processors 124 include hardware, software executed by hardware, or a combination of both, configured to reprovision the network devices 112 to perform one or more tasks in the device groups 116. In some embodiments, the one or more server processors 124 are configured to determine communication reciprocity for a specific network device 112 within a specific device group 116. The one or more server processors 124 may be one or more routing devices configured to route resources in the network 114 to additional network devices 112. In some embodiments, the one or more server processors 124 may be included on a same card or die. In this regard, the one or more server processors 124 may be configured to determine types of data exchanged by the network devices 112. The types of data may include sound, video, or informational details associated with any of the network devices 112.

In other embodiments, the processing engine 126 may be software executed by hardware and configured to dynamically aid the network devices 112 to maintain synchronization parameters during synchronization operations. The processing engine 126 may be implemented by the one or more server processors 124 operating as specialized hardware accelerators. The processing engine 126 may be configured to implement networking-specific processing tasks in custom logic and achieve better performance than typical software implementations. For example, the processing engine 126 may be lookup engines (e.g., using specialized logic), cryptographic coprocessors, content inspection engines, and the like. In some embodiments, the one or more processing engines configured to operate the secured databases 128 via execution of one or more of the instructions 132.

In one or more embodiments, the server processor 124 is hardware, software executed by hardware, or a combination of both configured to regulate the types of data shared among two or more of the network devices 112 and/or between the server 102 and one or more of the network devices 112. In some embodiments, the server 102 may assist in establishing a communication link (examples shown in reference to FIGS. 2 and 3) between any two or more network devices 112 and/or between the server 102 and one or more of the network devices 112. In implementing the communication links, the server 102 may monitor data shared by each of the network devices 112 and control that specific types of data are reciprocated to at least one of the network devices 112. In this regard, the server processor 124 may regulate the types of data presented at a given network device 112 based at least in part upon the types of data that the given network device is configured to share. In some embodiments, the server processor 124 may be configured to schedule timings for transmissions of multiple network devices 112 to evaluate the data transmitted. In other embodiments, the server processor 124 may be configured to determine multiple data exchange settings (e.g., communication preferences of a given network device 112) and determine whether the given network device 112 is configured to share a specific type of data. The server processor 124 may include a security chipset configured to establish one or more physical gates/firewalls at the server 102 or at one or more of the network devices 112, a wireless chipset configured to provide wireless connectivity capabilities, and a routing chipset configured to regulate data exchanging capabilities by reducing or increasing access to specific types of data. In other embodiments, the security chipset, the wireless chipset, and the routing chipset may be combined into a same chipset sharing common memory resources and processing resources.

In one or more embodiments, the secured databases 128 may be configured to store one or more data elements and/or record elements. The secured databases 128 may be a secured storage communicatively coupled with and/or located in the server 102. The secured storage may be a secured data storage, a secured chipset, or the like. The secured databases 128 may include the digital credentials 104, one or more claims 172, one or more keys 174, one or more encrypted identifiers (ID) 176, and one or more signatures 178 among others. The secured databases 128 may be secured with multiple firewalls and/or authentication protocols. The secured databases 128 may be configured to store encrypted data, secured data elements, and/or tokens representative of actual data. The one or more claims 172 may be one or more permission and/or permission requests to access one or more of the network resources 110. The one or more claims 172 may represent attributes that are required to access a network resource 110. For example, if a user has a “Top Secret” claim, the user would be granted access to restricted network devices based on an authorization policy that is separate for the claim 172 itself. The one or more claims 172 may be one or more assertions made a given user 119 and/or required by an organization for the given user 119 and/or one or more network devices 112. The one or more claims 172 may be one or more claimed entitlements associated with one or more users 119 and/or one or more network devices 112. The one or more keys 174 may be one or more passphrases, encryption keys, passwords, passkeys, access commands, decryption parameters, and/or pin codes configured to enable decryption, encryption, and/or combination of one or more data elements and/or one or more data records. The one or more encrypted IDs 176 may be one or more IDs associated with a given user 119 and/or one or more network devices 112 that are encrypted in accordance with one or more security protocols and/or encryption protocols. The encrypted IDs 176 may be representative encrypted versions of one or more IDs associated with a given user 119 and/or one or more network devices 112 instead of the actual IDs. The one or more encrypted IDs 176 may be one or more elements configured to be decrypted in accordance with one or more of the keys 174 and/or any additional number of decryption keys. The one or more signatures 178 may be a permanent or semi-permanent representation of a combination of bitstrings arranged in a specific order configured to represent one or more unique data exchange operations, a unique user 119, and/or one or more unique network devices 112. The digital credentials 104 may be one or more credentials generated to be representative of the identity of a user 119 and/or a network device 112. The digital credentials 104 may be one or more bitstrings, text data, and/or image data representative of one or more aspects of the candidate profiles 106.

While shown as part of the secured databases 128, one or more of the digital credentials 104, one or more claims 172, one or more keys 174, one or more encrypted identifiers (ID) 176, and one or more signatures 178 may be stored in the device memory 166 and/or an alternative secured storage communicatively coupled to the server 125 and/or the network devices 112.

In one or more embodiments, the server memory 130 includes mass storage for data or instructions. As an example, and not by way of limitation, the server memory 130 may include a solid-state drive (SSD), a hard disk drive (HDD), a floppy disk drive, flash memory, an optical disc, a magneto-optical disc, magnetic tape, or a Universal Serial Bus (USB) drive or a combination of two or more of these. The server memory 130 may include removable or non-removable (or fixed) media, where appropriate. In some embodiments, while the secured databases 128 and the server memory 130 are shown as separate portions of the server 102, the secured databases 128 and the server memory 130 may be included in a same memory unit and/or one or more additional memory units. Further, the server memory 130 may be protected and/or encrypted as described in reference to the secured databases 128. The server memory 130 may be internal or external to a computer system, where appropriate. In particular embodiments, the server memory 130 is non-volatile, solid-state memory. In particular embodiments, the server memory 130 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates the server memory 130 as a mass storage taking any suitable physical form. The server memory 130 may include one or more storage control units facilitating communication between the one or more server processors 124 and the server memory 130, where appropriate. Although this disclosure describes and illustrates particular storage, this disclosure contemplates any suitable storage.

In one or more embodiments, the server memory 130 includes a main memory for storing the instructions 132 for the one or more server processors 124 to execute or data for the one or more server processors 124 to operate on. As an example, and not by way of limitation, the network devices 112 may load the instructions 132 from another memory in the network devices 112. The one or more server processors 124 may then load the instructions 132 from the server memory 130 to an internal register or internal cache. To execute the instructions 132, the one or more server processors 124 may retrieve the instructions 132 from the internal register or internal cache and decode them. During or after execution of the instructions 132, the one or more server processors 124 may write one or more results (which may be intermediate or final results) to the internal register or internal cache. The one or more server processors 124 may then write one or more of those results to the server memory 130. In some embodiments, the one or more server processors 124 executes only the instructions 132 in one or more internal registers or internal caches or in the server memory 130 and operates only on data in one or more internal registers or internal caches or in the server memory 130.

In one or more embodiments, the server memory 130 includes commands or data associated with one or more specific applications in addition or as part of the instructions 132. In FIG. 1, the server memory 130 includes the instructions 132, one or more candidate profiles 106 including candidate information 134, one or more entitlements 136, and one or more biometric data 138 associated with one or more users 119 and/or one or more network devices 112, one or more request bitstrings 140, one or more encryption/decryption operations 142, at least one reference repository 144 including one or more reference bitstrings 146, collected information 148 including image data 150 and one or more digital biometrics 152 (e.g., a unique digital biometric comprising facial, finger, audio, retinal, and/or some combination of these biometrics) associated with one or more users 119 and/or one or more network devices 112, the one or more requests 108, access to one or more network resources 110 and one or more rules and policies 154.

The one or more candidate profiles 106 may be configured to provide access to configuration parameters for the network devices 112 to operate (e.g., perform one or more tasks) in the device groups 116. The candidate information 134 may be one or more collected information 148 associated with a specific user 119 and/or a specific network device 112. The candidate information 134 may be information, data elements, and/or data records representative of IDs associated with users 119 and/or network devices 112. The entitlements 136 may be configured to provide one or more connectivity allowances to the network devices 112 in the device groups 116. For example, in accordance with one of the candidate profiles 106 corresponding to the network device 112b, the network device 112b may be a desktop computer or communication terminal configured to communicate and route signaling among some of the additional network devices 112. In this regard, the entitlements 136 associated with a corresponding candidate profile 106 of the network device 112b may indicate that the network device 112b is allowed to communicate with one or more components in the network 114 (e.g., core network components or servers including specific network functions (NF)) to communicate and route signaling. The biometric data 138 may be images and/or sound collected in accordance with a verification protocol. The biometric data 138 may include iris scans, fingerprints, voice commands, behavioral patterns, heat sensing, proximity movement, and/or tracked geolocation of a given user 119 and/or a given network device 112.

The one or more request bitstrings 140 may be one or more alphanumeric representations of data or data itself. The request bitstrings 140 may be generated in accordance with one or more digitalization protocols and may be configured to represent information. In some embodiments, a request bitstrings 140 is generated based on candidate information 134 and/or collected information 148. The request bitstrings 140 may be an alphanumeric string of data configured to represent one or more signals, commands, and/or signatures 178 that reference IDs or identification for a given user 119 and/or a network device 112.

The one or more encryption/decryption operations 142 may be one or more encryption operations and/or one or more decryption operations. The encryption operations may include safeguarding information using one or more of the keys 174 and/or additional key elements, preventing access to information by scrambling, shifting, altering, adding, removing, and/or processes to protect information. The decryption operations may include safely retrieving information using one or more of the keys 174 and/or additional key elements, obtaining controlled access to information by unscrambling, reorganizing, rearranging, adding, removing, and/or processes to access information.

At least one repository 144 may be one or more databases and/or access networks configured to provide one or more reference bitstrings 146. The one or more reference bitstrings 146 may be one or more alphanumeric string of data verified by one or more third parties, and/or third-party organizations, represent one or more signals, commands, and/or signatures 178 that reference IDs or identification for a given user 119 and/or a network device 112. The at least one repository 144 may be hosted by an organization that is not directly associated with the server 102. The at least one repository 144 may be hosted with an organization associated with the server 102. The repository 144 may be hosted by a same organization that created and/or issued one or more IDs for the users 119 and/or the network devices 112. The repository 144 may be hosted by an organization that is different from an organization that created and/or issued one or more IDs for the users 119 and/or the network devices 112.

The collected information 148 may be image data 150 and/or digital biometrics 152 associated with one or more surroundings of the server 102 and/or one or more network devices 112. The collected information 148 may be obtained using one or more sensors included in the one or more server I/O interfaces 122 in the server 102 and/or the one or more device I/O interfaces 160 in one or more of the network devices 112. The collected information 148 may be one or more data elements and/or data records obtained from a specific database, inputs entered by one or more users 119, and/or one or more data packets received at least partially via the network 114. The image data 150 may be scans of portions of the user 119 and/or the network devices 112. The image data may be images of certificates and/or IDs associated with the user 119 and/or the network devices 112. The candidate information 134 may be representative of image data 150 associated with the user 119 and/or the network devices 112. The one or more digital biometrics 152 may be one or more historical and/or current patterns associated with the behavior of a user 119 and/or a network device 112. The patterns may be one or more electronic operations that are monitored in one or more of the network devices over time. The candidate information 134 may be representative of at least one digital biometric 152 associated with the user 119 and/or the network devices 112.

The one or more requests 108 may be configured to request onboarding and/or access for an entity. Herein, an entity may include at least one network device 112 and/or at least one user 119 using a network device 112. The requests 108 may be configured in accordance with one or more communication protocols. The requests 108 may be one or more signals and/or commands configured to trigger operations in the server 102.

The one or more network resources 110 may be at least a portion of systems and/or devices associated with a network. In some embodiments, the network resources 110 may be cloud resources, power resources, memory resources, and processing resources that are consumed in attempts to access services and/or applications in a given communication system 100. In other embodiments, the network resources 110 may be audio, visual, and/or sound data configured to be packaged as data streamed for playback. For example, the network resources 110 may include access to one or more applications in a network. In another example, the network resources 110 may include access to one or more databases and/or data storages associated with the server 102.

In some embodiments, the multiple rules and policies 154 may be information commanding rules and/or operations of the system 100. The rules and policies 154 may be updated dynamically or periodically over time. For example, the rules and policies 154 may provide guidelines to access, receive and transmit information using the server I/O interfaces 122. In other embodiments, the rules and policies 154 may be procedure or operational guidelines predefined by one or more organizations associated with the server 102. The rules and policies 154 may be one or more operation preferences that may include information associated with, or updated by, the network devices 112. The rules and policies 154 may be predefined data exchange parameters set in accordance with one or more operation preferences. For example, an organization may predefine in the rules and policies 154 of a given candidate profile 106 that a given network device 112 is configured to exchange both video and sound during a communication exchange. Further, the rules and policies 154 may be dynamically modified data exchange parameters by a user 119 associated with a given network device 112. For example, a user 119 may set the rules and policies 154 to transmit specific data types during a communication exchange.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), random access memory (RAM)-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

In one or more embodiments, the network 114 may be a combination of electronic devices forming a multi-node mesh. As an example, and not by way of limitation, one or more portions of the network 114 may include an ad hoc network, an intranet, an extranet, a virtual private network (VPN), a LAN, a wireless LAN (WLAN), a WAN, a wireless WAN (WWAN), a MAN, a portion of the Internet, a portion of the Public Switched Telephone Network (PSTN), a cellular technology-based network, a satellite communications technology-based network, another network 114, or a combination of two or more such networks.

In one or more embodiments, any one of the device groups 116 may include thousands of network devices 112 exchanging data with one another simultaneously, in accordance with their respective device groups 116, or in accordance with one or more sub-groups of network devices 112. In some embodiments, the network devices 112 represent devices that are capable of receiving real-time data packet transmissions and may include general purpose computing devices (e.g., servers, workstations, desktop computers, and the like), mobile computing devices (e.g., laptops, tablets, mobile phones, and the like), wearable devices (e.g., watches, glasses, or other head-mounted displays (HMDs), ear devices, and the like), and so forth. The network devices 112 may also include Internet of Things (IoT) devices or equipment, such as agricultural equipment (e.g., livestock tracking and management systems, watering devices, unmanned aerial vehicles (UAVs), and the like); connected cars and other vehicles; smart home sensors and devices (e.g., alarm systems, security cameras, lighting, appliances, media players, Heating Ventilation, and Air Conditioning (HVAC) equipment, utility meters, windows, automatic doors, door bells, locks, etc.); office equipment (e.g., desktop phones, copiers, fax machines, and the like); healthcare devices (e.g., pacemakers, biometric sensors, medical equipment, and the like); industrial equipment (e.g., robots, factory machinery, construction equipment, industrial sensors, and the like); retail equipment (e.g., vending machines, point of sale (POS) devices, Radio Frequency Identification (RFID) tags, and the like); smart city devices (e.g., street lamps, parking meters, waste management sensors, and the like); transportation and logistical equipment (e.g., turnstiles, rental car trackers, navigational devices, inventory monitors, and the like); and so forth.

Referring to the network device 112a as a non-limiting example, the network devices 112 may include one or more device I/O interfaces 160 configured to perform one or more data exchange operations, a device processor 162 including a device processing engine 164, and a device memory 166 including one or more device instructions 168 and one or more digital wallets 170. In one or more embodiments, the one or more network devices 112 include end-network devices such as laptops, phones, tablets, and any other suitable device that are capable of receiving, creating, processing, storing, or communicating information, including data packet transmissions.

The device I/O interfaces 160 may be configured to perform one or more of the operations described in reference to the server I/O interfaces 122. For example, the device I/O interfaces 160 may be configured to perform one or more data exchange operations described in reference to the server I/O interfaces 122. The device processor 162 may be configured to perform one or more of the operations described in reference to the one or more server processors 124, the device processing engine 164 may be configured to perform one or more of the operations described in reference to the server processing engine 126, and the device memory 166 may be configured to perform one or more of the operations described in reference to the server memory 130. In some embodiments, the device instructions 168 may be used to perform one or more of the operations described in reference to the instructions 132. The digital wallet 170 may be a software program, online service, or electronic device configured to securely store payment information associated with a user 119 and/or a network device 112. The digital wallet 170 may be configured to store information and/or one or more data objects configured to be exchanged in accordance with one or more data exchange operations.

FIG. 2 shows an example operational flow 200 to dynamically onboard an entity into an organization, in accordance with one or more embodiments. In FIG. 2, the operational flow 200 may be performed by different components in the server 102. In particular, the operational flow 200 may be performed using the one or more server processors 124. As a non-limiting example, the server 102 may be configured to verify information associated with at least one candidate 210. The server 102 may be configured to perform one or more operations to verify candidate information 134 and possibly generate one or more digital credentials 104. Herein, the server 102 may be configured to perform one or more of operations 220-256. In some embodiments, while operations 220-256 are shown in a specific order, alternative arrangements may be performed such as one or more operations being performed in different sequences, in parallel, and/or omitting one or more of the operations 220-256. The operations 220-256 may cause one or more manual verifications 260, one or more digital verifications 262, one or more candidate rejection reports 264, data to be provided to one or more claim storages 266, generation of one or more triggers 268, data to be retrieved from one or more key storages 270, trigger operations of one or more encryption components 272, generation of one or more candidate digital credentials 274, and data to be stored in one or more digital credential storages 276.

The operational flow 200 may start with the server 102 obtaining at least one ID from the candidate 210. The candidate 210 may be associated with specific candidate profile 106. In some embodiments, while one or more operations 220-256 may be described in reference to the server 102, a network device 112 associated with the server 102 may be configured to perform one or more of the operations 220-256. The candidate 210 may be at least one network device 112 and/or at least one user 119 interacting with the server 102 via at least one network device 112. At operation 220, the candidate 210 may provide the ID to the server 102. In some embodiments, the ID may be provided to the server 102 directly or indirectly. The server 102 may obtain the ID as collected information 148. At operation 222, the server 102 may be configured to determine whether the ID requires one or more manual verifications 260 and/or one or more digital verifications 262. At operation 224, the server 102 is configured to determine that the ID requires one or more manual verifications 260 where the ID and/or information collected from the ID is confirmed using manual methods, such as keying data from the ID into an application, confirming collection of the ID using biometrics (e.g., to confirm biometric data 138 associated with the specific candidate profile 106), and/or evaluating the contents of the ID using one or more sensors associated with the server 102 and/or the network device 112. At operation 226, the server 102 is configured to determine that the ID requires one or more digital verifications 262 where the ID and/or information collected from the ID is confirmed using digital methods, such as comparing image data 150 collected from the ID data, confirming collection of the ID using biometrics (e.g., to confirm biometric data 138 associated with the specific candidate profile 106), and/or evaluating the contents of the ID using one or more reference IDs associated with the server 102 and/or the network device 112. Although not shown in FIG. 2, the operational flow 200 may include performing one or more manual verifications 260 in addition to one or more digital verification 262.

At operation 226, the server 102 may be configured to generate a result from the verifications. At operation 230, the server 102 is configured to determine whether the ID is verified. At operation 232, the server 102 is configured to determine that the ID is not verified and generate one or more candidate rejection reports 264. The candidate rejection reports 264 may be provided to the network device 112, one or more additional network devices, and/or one or more systems communicatively coupled to the network 114. At operation 236, the server 102 is configured to determine that the ID is verified and trigger one or more candidate claim operations 240. While shown to include operations 242-256, the candidate claim operations 240 may be configured to include less or more additional operations.

At operation 242, the server 102 may be configured to generate one or more claim requests 108. The claim requests 108 may include generating one or more claims 172 to be associated with the candidate 210. The claim requests 108 may be configured to sort, generate, and/or trigger creation and/or storage of one or more of the claims 172. At operation 244, the server 102 may be configured to provide one or more specific claims 172 to the one or more claim storages 266. At operation 246, the server 102 may be configured to generate one or more triggers configured to cause creation of one or more digital credentials 104. At operation 248, the server 102 may be configured to cause confirmation of one or more portions of candidate information 134. At operation 250, the server 102 may be configured to generate and/or obtain one or more keys 174 from one or more key storages 270. At operation 252, the server 102 may be configured to perform one or more encryption/decryption operations 142. In some embodiments, one or more encryption components 272 may be configured to encrypt the claims 172 with one or more keys 174. At operation 254, the encryption components 272 (e.g., the processor 124 and/or the device processor 162) may be configured to generate one or more candidate digital credentials 274 (e.g., one or more digital credentials 104). At operation 256, the server 102 may be configured to generate the candidate digital credentials 274 to one or more digital credential storages 276. The digital credential storages 276 may be one or more digital wallets 170. The digital credential storages 276 may be one or more digital wallets 170 that are biometrically tied to the candidate.

In some embodiments, the claim storages 266, the key storages 270, and the digital credential storages 276 may be included as part of one or more secured databases 128 and/or the digital wallet 170. In other embodiments, the claim storages 266, the key storages 270, and the digital credential storages 276 may be included as part of the digital wallet 170 that are biometrically tied to the candidate.

As a non-limiting example, the operational flow 200 may include one or more onboarding operations to be completed during an interview stage in a specific organization. During the interview stage, the server 102 on behalf of a hiring company (e.g., organization) may validate that the candidate 210 is indeed a person as claimed. For digital verifications 262, the server 102 may ensure liveness and establish a cryptographic relationship between the candidate 210 and an approved identity issuer. This operational flow 200 may begin either with a physical document or a government-issued digital credential (e.g., such as a digital driver's license). The operational flow 200 may results in the candidate being issued a digital credential from the hiring organization that may serve to track that a new hire is indeed the interviewed candidate. The level of assurance for all stages may be at least a level 3, as described in one or more National Institute of Standards and Technology (National Institute of Standards and Technology) Special Publications (SP), such as NIST SP 800-63-3 which described levels of assurance (LOA).

The operational flow 200 may be used to validate an “identity chain” from the beginning to the end of the interview stage, in accordance with certain embodiments. The details of the operational flow 200 are as follows. At operation 220, the candidate 210 may be configured to submit an approved credential as designated by an enterprise to the server 102. The approved credential may be a government-issued document (e.g., driver's license, passport, and the like). At operation 222, the server 102 may be configured to determine whether to use one or more of the manual verifications 260 and/or the digital verifications 262. At the manual verifications 260, the server 102 may be configured to follow the organization's rules and policies 154 to validate physical credentials of the candidate 210, such as a driver's license, passport, social security card, or the like. At the digital verifications 262, the server 102 may be configured to follow the organization's rules and policies 154 to validate digital credentials of the candidate 210, such as a digital driver's license, a digital passport, a digital entry card, or the like. The verification processes may occur live (e.g., in-person) or remotely (e.g., via live video conferencing).

In some embodiments, digital verifications may be used as government credentials become available via one of the emerging verifiable credentials (VC) standards, such as mobile driver's license (mDL) as described in ISO/IEC 18013-5, W3C Verifiable Credentials, Selective Disclosure JSON Web Tokens (SD-JWTs), and the like. Cryptographic methods may be used to validate the authenticity of these issued digital credentials. A government agency may hold a private key used to sign the claims 172 associated with a given digital credential 104. The claims 172 may include personal information and/or portions of the candidate information 134, such as driver's license number, date of birth, home address, physical characteristics, and the like.

The digital signature that is part of the digital credential 104 may be cryptographically verified using the government agency's public key. Common asymmetric public-private key pair cryptographic methods may be used for this purpose. In order for the candidate to present the digital credential 104 to the server 102, the server 102 may have the candidate use an accepted form of biometric mechanism to enable presentation and transmission of the digital credential 104 from the candidate's digital wallet 170 to a digital verification system. In certain embodiments, a combination of both manual and digital verifications may be used to validate a candidate's credentials since not all credentials may be available in digital format. The result may be digital and verifiable from that point forward.

At operation 232, if the credentials are not verified, then the candidate 210 may be rejected for consideration (permanently or at least temporarily) and the interview process may be terminated.

At operation 236, if the credentials are verified with the corresponding claims 172 and successfully matched with the candidate 210, then the interview process may continue. The verification process may involve checking a digital signature of the government issued credential, which may show that the credential was issued by a valid government agency. The digital signature verification process may involve using the government agency's official public key to verify the signature that was signed using the government agency's private key. Once the signature is verified, the credentials date of expiry and other claims that the enterprise requires may be checked.

At operation 242, once the candidate's credentials and claims 172 are verified, the operational flow 200 may proceed with issuing a digital credential that is given to the candidate for presentation during additional on-boarding and/or hiring processes. The digital credential 104 may include and/or reference the claims 172 (e.g., photos, contact information, date of birth, educational information, and the like) associated with the candidate 210. The claims 172 may be useful during the hiring process. The claims 172 associated with the digital credential 104 may vary greatly depending on the credential's usage. For example, proposed grade level and roles for IT usage, geographical restrictions for where onboarding takes place, restrictions on the candidate credential's usage for only onboarding, and/or other bound claims may be used to support the onboarding workflows. In this regard, the digital credential 104 may ensure, throughout the hiring process, that the identity of the candidate is not changed.

At operation 244, a minimal amount of the candidate's information (i.e., credential claims 172) may be stored by the interviewing organization in the claim storages 266. This may include a candidate credential identifier, candidate name/identifier, and/or contact information. Other claims may be stored as part of the candidate digital credential 104, which may be stored in the candidate's wallet and not within the interviewing organization's systems. In some embodiments, an interview/candidate system may store certain candidate details. Herein, the system 100 is configured to certify these details on a given network device 112 of a user 119 as well, by way of the digital credential 104. In other embodiments, the system 100 may be configured to only store a subset of the claims 172 and keep some sensitive information only stored with the digital credential 104. The system 100 may be configured to store a hash of the personal information claims. In certain embodiments, when the claims 172 are presented again, the hash may be calculated and compared with the stored claims 172.

At operation 246, for any claims that are not be stored in the interviewing organization's system, a digital credential may be created for the candidate. These claims 172 may be temporary digital credentials that expire after a fixed period specified by the interviewing organization's rules and policies 154. The candidate digital credentials may be revoked at any time and/or after a completion of the hiring/on-boarding process. In certain embodiments, the interviewing organization may not keep a copy of the candidate digital credential. This approach may reduce, inhibit, and/or limit exposure of personal identifiable information, assuming that the stored claims are also limited.

At operation 254, the candidate digital credential and its claims 172 may be cryptographically hashed and signed using the private key that is solely associated with the interviewing organization. Herein, the server 102 ensures that the digital credentials 104 may be verified as originating with the interviewing organization and whether contents of the digital credentials 104 are not tampered with. The private key of the user may also be required. The public key may be stored by the server 102.

At operation 254, once the candidate digital credential and claims 172 are signed, the digital credential 104 for the candidate 210 may be issued from the interviewing organization to the candidate's digital wallet 170. The storage and retrieval of the candidate digital credential may require some form of biometric identity verification (e.g., fingerprint, iris, facial recognition, and the like) from the candidate 210.

At operation 256, once the biometric identity is validated, the candidate digital credential may be stored in an encrypted digital wallet store on a network device 112 associated with the candidate 210 or a system under a direct control of the candidate 210, which may support biometric identity verification.

In certain embodiments, a fallback scenario exists for the interview stage that may not require creation and/or issuance of a candidate credentials for purposes of legacy compatibility. In this regard, only operation 244 may be performed to collect and store candidate claims 172. The claims 172 may be re-verified during the onboarding stage. Herein, operations 246-256 may be skipped if the candidate credential is not issued.

FIG. 3 shows an example operational flow 300 to dynamically confirm an entity previously onboarded into an organization, in accordance with one or more embodiments. In FIG. 3, the operational flow 300 may be performed by different components in the server 102. In particular, the operational flow 300 may be performed using the one or more server processors 124. As a non-limiting example, the server 102 may be configured to confirm information associated with at least one candidate 310. The server 102 may be configured to perform one or more operations to verify and/or confirm one or more digital credentials 104. Herein, the server 102 may be configured to perform one or more of operations 320-358. In some embodiments, while operations 320-358 are shown in a specific order, alternative arrangements may be performed such as one or more operations being performed in different sequences, in parallel, and/or omitting one or more of the operations 320-358. The operations 320-358 may cause data to be retrieved from one or more claim storages 362, one or more candidate validation scenarios 364, one or more candidate validation scenarios 366, data to be retrieved from one or more key storages 368, performance of one or more validations 370, generation of one or more candidate rejection reports 372, generation of one or more access triggers 374 to issue one or more ID/digital credential hybrids 376, one or more system digital credentials 378, and one or more office/site digital credentials 380 for storage in one or more digital credential storages 382, issue one or more passkeys 384 for storage in one or more passkey storages 386, and/or issue one or more device certifications 388. In some embodiments, a same user may use the one or more candidate validation scenarios 364 and/or the one or more candidate validation scenarios 366. In this regard, the one or more candidate validation scenarios 364 and the one or more candidate validation scenarios 366 may be alternative methods for a same user to validate one or more digital credentials 104.

The operational flow 300 may start with one or more candidate validation operations 320 configured to obtain and validate one or more digital credentials 104. the server 102 obtaining one or more claims 172 from the claim storage 362 at operation 322. At operation 324, the server 102 may be configured to receive one or more digital credentials 104 from one or more outside organizations, which may be digital credentials 104 in accordance with one or more candidate validation scenarios 364. At operation 326, the server 102 may be configured to receive one or more digital credentials 104 from a digital wallet 170, which may be digital credentials 104 in accordance with one or more candidate validation scenarios 366. The candidate 310 and/or the candidate 312 may be associated with the claims 172. The candidate validation scenarios 364 may include be one or more operations in which the digital credentials 104 are generated using a third party and/or organization that is not associated with the server 102. The candidate validation scenarios 366 may include be one or more operations in which the digital credentials 104 are generated using an organization that is associated with the server 102. At operation 328, the server 102 may be configured to receive at least one key 174 associated with the candidate 312. In some embodiments, while showing the candidate 310 and the candidate 312 as separate entities, the candidate 310 and the candidate 312 may be a same entity attempting to access network resources 110 via the server 102 using digital credentials 104 issued under the candidate validation scenario 364 and the candidate validation scenarios 366, respectively.

The candidate 310 and/or the candidate 312 may be associated with specific candidate profile 106. In some embodiments, while one or more operations 322-358 may be described in reference to the server 102, a network device 112 associated with the server 102 may be configured to perform one or more of the operations 322-358. The candidate 310 and/or the candidate 312 may be at least one network device 112 and/or at least one user 119 interacting with the server 102 via at least one network device 112. At the operation 324 and at the operation 326, the candidate 310 and/or the candidate 312 may provide the digital credentials 104 to the server 102. In some embodiments, the digital credentials 104 may be provided to the server 102 directly or indirectly.

The server 102 may be configured to perform one or more validations 370 in which the digital credentials 104 are validated. At operation 330, the server 102 may be configured to generate a result from the validations 370. At operation 332, the server 102 is configured to determine whether the digital credentials 104 are verified. At operation 334, the server 102 is configured to determine that the digital credentials 104 are not validated and generate one or more candidate rejection reports 372. The candidate rejection reports 372 may be provided to the network device 112, one or more additional network devices, and/or one or more systems communicatively coupled to the network 114. At operation 236, the server 102 is configured to determine that the digital credentials 104 are validated and triggers one or more credential generation operations 340. While shown to include operations 342-358, the credential generation operations 340 may be configured to include less or more additional operations.

The credential generation operations 340 may include one or more operations in which the server 102 is configured to provide access between the network resources 110 and the candidate 310 and/or the candidate 312. In some embodiments, the server 102 may be configured to create one or more access triggers 374 based on the claims 172 associated with a given entity. At operation 342, the server 102 may be configured to generate one or more ID/digital credential hybrids 376 for the given candidate. The ID/digital credential hybrids 376 may be one or more modified versions of the digital credentials 104 configured to integrate one or more local IDs that provide access between the candidate 310 and/or the candidate 312 and the network resources 110. At operation 344, the server 102 may be configured to provide the ID/digital credential hybrids 376 to one or more digital credential storages 382. At operation 346, the server 102 may be configured to generate one or more system digital credentials 378 for the given candidate. At operation 348, the server 102 may be configured to provide the system digital credentials 378 to one or more digital credential storages 382. The system digital credentials 378 may be one or more modified versions of the digital credentials 104 configured to integrate one or more system-specific access and/or parameters that provide access between the candidate 310 and/or the candidate 312 and the network resources 110. The system digital credentials 378 may be specific to a specific system and/or sub-system in associated with the server 102. At operation 350, the server 102 may be configured to generate one or more office/site digital credentials 380 for the given candidate. At operation 352, the server 102 may be configured to provide the office/site digital credentials 380 to one or more digital credential storages 382. The office/site digital credentials 380 may be one or more modified versions of the digital credentials 104 configured to integrate one or more office and/or site-specific access that provide access between the candidate 310 and/or the candidate 312 and the network resources 110. The office/site digital credentials 380 may be specific to a specific location in an office, a site, and/or space associated with the server 102. At operation 354, the server 102 may be configured to generate one or more passkeys 384 for the given candidate. At operation 356, the server 102 may be configured to provide the passkey 384 to one or more passkey storages 386. At operation 358, the server 102 may be configured to generate one or more device certifications 388 for the given candidate. The device certifications 388 may be one or more certificates configured to represent proof of access between the candidate 310 and/or the candidate 312 and the network resources 110. The device certifications 388 may be specific to a specific set and/or sub-set of network resources 110.

In some embodiments, the claim storages 362, the key storage 368, the digital credential storages 382, and the passkey storages 386 may be included as part of one or more secured databases 128 and/or the digital wallet 170.

As a non-limiting example, the operational flow 300 may include one or more confirmation operations to be completed during a first day stage in a specific organization. During the first day stage, an established cryptographic relationship may be validated, and authenticity and uniqueness may be confirmed (e.g., “is this a same ‘Jane Doe’ that was interviewed?”). After the candidate 310 and/or the candidate 312 receives offers to join the organization, the organization may confirm onboarding for specific entities, to provide access to one or more network resources 110 of the systems and/or facilities of the organization.

The operational flow 300 may be used to verify a given candidate (e.g., the candidate 310 and/or the candidate 312) and issue access credentials to the given candidate, in accordance with certain embodiments. As part of the candidate validation operations 320, having accepted an offer to return and starting the onboarding process in-person or remotely, the given candidate may present the candidate digital credential 274 that was issued during the interview stage described in association with the example of FIG. 2. The candidate digital credential 274 may require biometric identity verification to access the digital credentials 104 from a digital wallet 170 and present the digital credentials 104 to the server 102. The server 102 may be configured to enable verification that the candidate uses a biometric identification method to access the digital wallet 170 and present the candidate digital credential 274.

As part of the validations 370, after receiving the candidate digital credential 274, the server 102 may be configured to read the public key held in a secured database 128. The server 102 may comprise a verification system that reads the signature 178 from the candidate digital credential 274 and calculates a hash value of the claims 172 using a same hashing function used to create the digital signature 178. Then, the server 102 is configured to decrypt the signature 178 sent in the candidate digital credential 274, which contains a hash of the claims 172 when the digital credential was issued or presented to a verifier. Herein, if the decrypted hash matches the calculated hash value of the claims 172, then the candidate digital credential is valid, unaltered, and created by the issuer. In this regard, the candidate is determined to be a same entity that was interviewed. In a fallback scenario, if a candidate credential is not issued, the server 102 may be configured to re-verify an original government-issued credential of the candidate. After re-verifying the government-issued credential, the claims 172 that were stored during the interview stage in the secured database 128 may be manually re-verified. At operation 234, if the specific candidate is rejected, then the onboarding process may be stopped.

At operation 338, the server 102 may be configured to transition to the credential generation operations 340. Once the candidate is validated, the server 102 may be configured to issue specific credentials to access one or more of the network resources 110. The credentials may include physical, as well as digital credentials. At operations 342-350, specific identifiers may be provided to the candidates. At operation 342, one or more ID/digital credential hybrids 376 may be issued. The ID/digital credential hybrids 376 may be digital credentials which are used to verify access to specific network resources 110 while simultaneously acting as IDs for one or more additional organizations. It may be used to provide access to systems and company physical sites, if the claims 172 are attached to the ID/digital credential hybrids 376. At operation 346, one or more system digital credentials 318 may be issued. The system digital credentials 318 may be optional and/or separate digital credentials 104 that include specific claims 172 attached to the candidate, which provide control access to computer systems and applications in the organization. Example of the claims 172 may include one or more system access roles and/or permissions for one or more applications and/or groups of applications.

At operation 350, one or more office/site digital credentials 380 may be issued. The office/site digital credentials 380 may be optional and/or separate digital credentials 104 that include claims 172 that enable physical access to offices and/or specific organization sites. Examples of these claims 172 may include an office/site list or a category of sites (e.g., non-confidential sites). At operation 354, an additional passkey 384 may be issued. The additional passkey 384 may be an optional and/or separate keys 174, such as a Web Authentication (WebAuthn) standard passkey that may be issued to the candidate to allow access to the network resources 110. The digital credentials may follow a different standard than the digital credentials 104 and provide many of the same protections. Allowing for this credential format may ease a transition for application developers from passwords towards digital credentials 104 by including a widely supported middle ground. At operation 358, the device certifications 388 and any other essential credentials may be optional and/or separately provisioned. The operational flow 300 may end once all employee credentials are issued.

In certain embodiments, fast identity online (FIDO)-compliant passkeys, digital wallets, and issuer-bound credentials (e.g., mobile driver's license/digital credentials) may be shared during one or more stages. The credentials may be more difficult to compromise than passwords and may be easier to use than ID cards.

FIGS. 4A and 4B show flowcharts of respective processes 400a and 400b to generate and/or validate one or more digital credentials 104 associated with a user 119 and/or a network device 112, in accordance with one or more embodiments. Modifications, additions, or omissions may be made to the process 400a of FIG. 4A or the process 400b of FIG. 4B. The process 400a of FIG. 4A or the process 400b of FIG. 4B may include more, fewer, or other operations than those shown below. For example, operations may be performed in parallel or in any suitable order. While at times discussed as the server 102, the one or more network devices 112, or components of any of thereof, any suitable system or components of the system 100 may perform one or more operations of the process 400a of FIG. 4A or the process 400b of FIG. 4B. For example, one or more operations 402-434 of process 400a may be implemented, at least in part, in the form of instructions 132 of FIG. 1, stored on non-transitory, tangible, machine-readable media (e.g., memory 130 of FIG. 1) that when run by one or more processors (e.g., one or more server processors 124 of FIG. 1) may cause the one or more processors to perform operations described in operations 402-434. In another example, one or more operations 452-484 of process 400b may be implemented, at least in part, in the form of device instructions 168 of FIG. 1, stored on non-transitory, tangible, machine-readable media (e.g., device memory 166 of FIG. 1) that when run by one or more processors (e.g., one or more device processors 162 of FIG. 1) may cause the one or more processors to perform operations described in operations 452-484.

In FIG. 4A, the process 400a starts at operation 402, where the server 102 is configured to receive a request 108 to generate a digital credential 104 for a candidate profile 106. At operation 404, the server 102 may be configured to generate a request bitstring 140 that represents at least a portion of candidate information 134 in the candidate profile 106. At operation 406, the server 102 may be configured to determine whether the request bitstring 140 matches a reference bitstring 146 in a reference repository 144.

The process 400a continues at operation 410, where the server 102 determines whether the bitstrings match. If the bitstrings do not match (e.g., NO), the process 400a continues to operation 412. If the bitstrings match (e.g., YES), the process 400a proceeds to operation 422. At operation 412, the server 102 may be configured to determine that the candidate information 134 is not verified. The process 400a may end at operation 414, where the server 102 may be configured to deny the request 108 to generate the digital credential 104 for the candidate profile 106. In one or more embodiments, the verification itself may comprise additional operations and not solely matching a single bitstring pair. In this regard, additional iterations of the request bitstring 140 may be generated with incremental additions of additional portions of the candidate information 134. For example, the multiple bitstrings may be used with the aim of confirming the identity of a candidate using a request bitstring 140 that only includes the candidate's name. In the event that multiple bitstring matches occur based on the portion of the candidate information 134 used, additional portions of the candidate information 134 may be used, such as including the candidate's address and/or description of the candidate's appearance.

The process 400a may continue at operation 422, where the server 102 is configured to determine that the candidate information 134 is verified. At operation 424, the server 102 may be configured to determine claims 172 based on one or more entitlements 136 in the candidate profile 106. At operation 426, the server 102 may be configured to store the claims 172 in a secured storage (e.g., one or more secured databases 128). At operation 428, the server 102 may be configured to generate the digital credential 104 for the candidate profile 106 representative of the candidate information 134. At operation 430, the server 102 may be configured to generate a private key (e.g., one or more of the keys 174) configured to validate the digital credential 104. At operation 432, the server 102 may be configured to sign the digital credential 104 using the private key. The process 400a may end at operation 434, where the server 102 is configured to issue the signed version of the digital credential 104 to a digital wallet 170 associated with the candidate profile 106. In some embodiments, a hash of the claims 172 may be encrypted by the candidate's key associated with the server 102 that is generating the digital credential 104. This encrypted hash value of the claims 172 and other metadata associated with the digital credential 104 may form the signature of the digital credential.

In some embodiments, there may be multiple digital credential formats, and there may be some variation within the formats. These digital credentials 104 may comprise a set of claims included as a set of key/value pairs (e.g., a set of values with corresponding associated labels such as a name associated with a user's name). The digital credential 104 may be configured to accomplish two things with those claims:

(1) Prove that the claims are true. This may be accomplished by having a trusted issuer sign the claims, either individually or collectively, using the trusted issuer's private key. This private key may remain with the trusted issuer, but a corresponding public key may be published to allow anyone to check that signatures made with the private key are valid.

(2) Prove that a person presenting the claims is the legitimate holder of those claims. This may be accomplished by including the holder's public key during the issuance process to be signed by the issuer. Then, during presentation, the holder of the digital credential also signs the claims to be validated as the owner of the public key included in the credential.

In all cases, private keys may not move. The private keys may never be transferred or transmitted. The private keys may be locked within a hardware security module tied to a biometric.

While the entire exchange between an issuer and a holder or a holder and a verifier may be encrypted in transit, generally, digital credential claims themselves may not be individually encrypted. This is because the digital credential 104 is meant to protect the validity and integrity of data.

If the digital credential 104 as a whole is encrypted at rest on the holder's device, this may not be with the credential's private key, but rather with a device-specific file system encryption key.

In FIG. 4B, the process 400b starts at operation 452, where the server 102 is configured to receive a validation request 108 to associate access to one or more network resources 110 in a network with a candidate profile 106. At operation 454, the server 102 may be configured to retrieve claims 172 associated with the candidate profile 106 from a secured storage (e.g., one or more of the secured databases 128). At operation 456, the server 102 may be configured to retrieve a public key from a key storage (e.g., one or more of the secured databases 128 or the digital wallet 170). At operation 458, the server 102 may be configured to determine whether a digital wallet 170 associated with the candidate profile 106 is accessed using biometrics associated with the candidate profile 106 (e.g., confirming biometric data 138).

The process 400b continues at operation 460, where the server 102 determines whether the digital wallet 170 is accessed using one or more biometrics. If the digital wallet 170 is not accessed using one or more biometrics (e.g., NO), the process 400b continues to operation 462. If the digital wallet 170 is accessed using one or more biometrics (e.g., YES), the process 400b proceeds to operation 472. At operation 472, the server 102 may be configured to receive a signed version of the digital credential 104 from the digital wallet 170 associated with the candidate profile 106. At operation 474, the server 102 may be configured to determine a candidate signature 178 based on the public key. At operation 476, the server 102 may be configured to calculate a claim signature 178 from the claims 172. At operation 478, the server 102 may be configured to determine whether the candidate signature 178 matches the claim signature 178.

The process 400b continues at operation 480, where the server 102 determines whether the signatures 178 match. If the signatures 178 do not match (e.g., NO), the process 400b continues to operation 462. If the signatures 178 match (e.g., YES), the process 400b proceeds to operation 482. At operation 482, the server 102 may be configured to determine that the signed version of the digital credential 104 from the digital wallet 170 associated with the candidate profile 106 is valid. The process 400b may end at operation 484, where the server 102 may be configured to associate access to one or more network resources 110 in the network with the candidate profile 106.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Additionally, although this disclosure describes or illustrates particular embodiments as providing particular advantages, particular embodiments may provide none, some, or all of these advantages.

The embodiments disclosed herein are only examples, and the scope of this disclosure is not limited to them. Particular embodiments may include all, some, or none of the components, elements, features, functions, operations, or steps of the embodiments disclosed herein.

Modifications, additions, or omissions may be made to the elements shown in the figures above. The components of a device may be integrated or separated. Moreover, the functionality of a device may be performed by more, fewer, or other components. The components within a device may be communicatively coupled in any suitable manner. Functionality described herein may be performed by one device or distributed across multiple devices. In general, systems and/or components described in this disclosure as performing certain functionality may include non-transitory computer readable memory storing instructions and processing circuitry operable to execute the instructions to cause the system/component to perform the described functionality.

While several embodiments have been provided in the present disclosure, it should be understood that the disclosed systems and methods might be embodied in many other specific forms without departing from the scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

Any appropriate steps, methods, features, functions, or benefits disclosed herein may be performed through one or more functional units or modules of one or more virtual apparatuses. Each virtual apparatus may include a number of these functional units. These functional units may be implemented via processing circuitry configured to execute program code stored in memory. The term unit may have conventional meaning in the field of electronics, electrical devices and/or electronic devices and may include, for example, electrical and/or electronic circuitry, devices, modules, processors, receivers, transmitters, memories, logic solid state and/or discrete devices, computer programs or instructions for carrying out respective tasks, procedures, computations, outputs, and/or displaying functions, and so on, as such as those that are described herein.

1. A system, comprising:
a memory configured to store:
a reference repository comprising a plurality of reference bitstrings; and a processor communicatively coupled to the memory and configured to:
receive a request to generate a digital credential for a candidate profile, the candidate profile comprising candidate information and a plurality of entitlements;
generate a request bitstring representative of the candidate information;
determine whether the request bitstring matches a reference bitstring from the plurality of reference bitstrings in the reference repository;
in response to determining that the request bitstring matches the reference bitstring from the plurality of reference bitstrings in the reference repository, determine that the candidate information is verified;
in response to determining that the candidate information is verified, determine a plurality of claims based on the plurality of entitlements, the plurality of claims being representative of one or more portions of the candidate information;
store the plurality of claims in a secured storage;
generate the digital credential for the candidate profile representative of the candidate information and the plurality of claims;
generate a private key configured to create a signature for the digital credential;
sign the digital credential using the private key; and
issue a signed version of the digital credential to a digital wallet associated with the candidate profile.

2. The system of claim 1, wherein the processor is further configured to:
receive an additional request to generate an additional digital credential for an additional candidate profile, the additional candidate profile comprising additional candidate information and an additional plurality of entitlements;
generate an additional request bitstring representative of the additional candidate information;
determine whether the additional request bitstring matches an additional reference bitstring of the plurality of reference bitstrings in the reference repository;
in response to determining that the additional request bitstring does not match the additional reference bitstring of the plurality of reference bitstrings in the reference repository, determine that the additional candidate information is not verified; and
in response to determining that the candidate information is not verified, deny the additional request to generate the additional digital credential for the additional candidate profile.

3. The system of claim 1, wherein:
the candidate information is representative of image data captured by a sensor.

4. The system of claim 1, wherein:
the candidate information is representative of a unique digital biometric associated with a user.

5. The system of claim 1, wherein:
the secured storage comprises a centralized database where additional claims associated with additional candidate profiles are stored.

6. The system of claim 1, wherein:
the secured storage comprises one or more decentralized databases that together store additional claims associated with additional candidate profiles.

7. The system of claim 1, wherein:
the signed version of the digital credential is issued to the digital wallet associated with the candidate profile for a predefined time duration.

8. A method, comprising:
receiving a request to generate a digital credential for a candidate profile, the candidate profile comprising candidate information and a plurality of entitlements;
generating a request bitstring representative of the candidate information;
determining whether the request bitstring matches a reference bitstring of a plurality of reference bitstrings in a reference repository;
in response to determining that the request bitstring matches the reference bitstring of the plurality of reference bitstrings in the reference repository, determining that the candidate information is verified;
in response to determining that the candidate information is verified, determining a plurality of claims based on the plurality of entitlements, the plurality of claims being representative of one or more portions of the candidate information;
storing the plurality of claims in a secured storage;
generating the digital credential for the candidate profile representative of the candidate information and the plurality of claims;
generating a private key configured to create a signature for the digital credential;
signing the digital credential using the private key; and
issuing a signed version of the digital credential to a digital wallet associated with the candidate profile.

9. The method of claim 8, further comprising:
receiving an additional request to generate an additional digital credential for an additional candidate profile, the additional candidate profile comprising additional candidate information and an additional plurality of entitlements;
generating an additional request bitstring representative of the additional candidate information;
determining whether the additional request bitstring matches an additional reference bitstring of the plurality of reference bitstrings in the reference repository;
in response to determining that the additional request bitstring does not match the additional reference bitstring of the plurality of reference bitstrings in the reference repository, determining that the additional candidate information is not verified; and
in response to determining that the candidate information is not verified, denying the additional request to generate the additional digital credential for the additional candidate profile.

10. The method of claim 8, wherein:
the candidate information is representative of image data captured in by a sensor.

11. The method of claim 8, wherein:
the candidate information is representative of a unique digital biometric associated with a user.

12. The method of claim 8, further comprising:
the secured storage comprises a centralized database where additional claims associated with additional candidate profiles are stored.

13. The method of claim 8, further comprising:
the secured storage comprises one or more decentralized databases that together store additional claims associated with additional candidate profiles.

14. The method of claim 8, further comprising:
the signed version of the digital credential is issued to the digital wallet associated with the candidate profile for a predefined time duration.

15. A non-transitory computer-readable medium storing instructions that, when executed by a processor, cause the processor to:
receive a request to generate a digital credential for a candidate profile, the candidate profile comprising candidate information and a plurality of entitlements;
generate a request bitstring representative of the candidate information;
determine whether the request bitstring matches a reference bitstring of a plurality of reference bitstrings in a reference repository;
in response to determining that the request bitstring matches the reference bitstring of the plurality of reference bitstrings in the reference repository, determine that the candidate information is verified;
in response to determining that the candidate information is verified, determine a plurality of claims based on the plurality of entitlements, the plurality of claims being representative of one or more portions of the candidate information;
store the plurality of claims in a secured storage;
generate the digital credential for the candidate profile representative of the candidate information and the plurality of claims;
generate a private key configured to create a signature for the digital credential;
sign the digital credential using the private key; and
issue a signed version of the digital credential to a digital wallet associated with the candidate profile.

16. The non-transitory computer-readable medium of claim 15, wherein, when executed by a processor, the instructions further cause the processor to:
receive an additional request to generate an additional digital credential for an additional candidate profile, the additional candidate profile comprising additional candidate information and an additional plurality of entitlements;
generate an additional request bitstring representative of the additional candidate information;
determine whether the additional request bitstring matches an additional reference bitstring of the plurality of reference bitstrings in the reference repository;
in response to determining that the additional request bitstring does not match the additional reference bitstring of the plurality of reference bitstrings in the reference repository, determine that the additional candidate information is not verified; and
in response to determining that the candidate information is not verified, deny the additional request to generate the additional digital credential for the additional candidate profile.

17. The non-transitory computer-readable medium of claim 15, wherein:
the candidate information is representative of image data captured in by a sensor.

18. The non-transitory computer-readable medium of claim 15, wherein:
the candidate information is representative of a unique digital biometric associated with a user.

19. The non-transitory computer-readable medium of claim 15, wherein:
the secured storage comprises a centralized database where additional claims associated with additional candidate profiles are stored.

20. The non-transitory computer-readable medium of claim 15, wherein:
the secured storage comprises one or more decentralized databases that together store additional claims associated with additional candidate profiles.
